(19) United States
(12) Patent Application Publication
(10) Pub. No.: US 2007/0043684 A1
(43) Pub. Date: Feb. 22, 2007

(54) Central Management of a Credential Production System

(75) Inventors: Kelly R. Nehowig, Maple Grove, MN (US); David T. Gale, Champlin, MN (US); Lisa A. Fischer, Plymouth, MN (US); Keith A. Platfoot, Eden Prairie, MN (US); John E. Ekers, Plymouth, MN (US); Thomas A. Zappe, Fridley, MN (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: FARGO ELECTRONICS, INC., Eden Prairie, MN (US)

(21) Appl. No.: 11/465,510

(22) Filed: Aug. 18, 2006

Related U.S. Application Data
(60) Provisional application No. 60/709,401, filed on Aug. 18, 2005.
(60) Provisional application No. 60/715,945, filed on Sep. 9, 2005.

(51) Int. Cl. G06Q 99/00

(52) U.S. Cl. 705/76

(57) ABSTRACT

A credential production system includes at least one credential production device, at least one computing device in communication with the at least one credential production device and a central administrator device configured to enable an authentication feature on the at least one credential production device. The at least one computing device is configured to access the at least one credential production device for providing processing instructions for processing a credential substrate. The at least one computing device is authenticated by the at least one credential production device prior to providing the processing instructions to the at least one credential production device.

The present application claims the benefit of U.S. provisional patent application Ser. No. 60/709,401 filed Aug. 18, 2006 and 60/715,945, filed Sep. 9, 2006, all of which are hereby incorporated by reference in their entirety.

### FIELD OF THE INVENTION

The present invention is generally directed to a credential production system. More particularly, the present invention is directed to methods and components for processing and managing a secure credential substrate using a credential production system.

### BACKGROUND OF THE INVENTION

Credentials include identification cards, driver's licenses, passports, and other valuable documents. Such credentials are formed from credential substrates including paper substrates, plastic substrates, cards and other materials. Such credentials generally include printed information, such as a photo, account numbers, identification numbers, and other personal information that is printed on the credential substrates using a print consumable, such as ink and ribbon. A secure overlaminate or security label may also be laminated to the surfaces of the credential substrate to protect the printed surfaces from damage or provide a security feature (e.g., hologram). Additionally, credentials can include data that is encoded in a smartcard chip, a magnetic stripe, or a barcode, for example.

Credential manufacturing systems or credential production systems generally include at least one credential processing device that processes a credential substrate to perform at least one step in forming the final credential product. Such credential processing devices include, for example, printing devices for printing images to the credential substrate, laminating devices for laminating an overlaminate to the credential substrate, devices for attaching labels, and encoding devices for encoding data to the substrate. Credential production devices process a credential substrate in response to a credential processing job generated by a credential producing application. The credential processing job generally defines the printing, laminating, attaching and/or encoding processes that are to be performed by the credential manufacturing device on the credential substrate.

When multiple credential production devices are deployed in a distributed credential production system computing environment, the administration of security features for accessing and transmitting production jobs from computing devices to credential production devices is difficult. Typically, each computing device would need to configure security features for each credential production device that it interacts with. Different computing devices can configure security features in different manners, which can confuse respective users using different computing devices to attempt to process jobs to the same credential production device.

Embodiments of the present invention provide solutions to these and other problems, and offer other advantages over the prior art.

### SUMMARY OF THE INVENTION

The following disclosure is directed to a secured credential production system. The credential production system includes at least one credential production device, at least one computing device in communication with the at least one credential production device and a central administrator device configured to enable an authentication feature on the at least one credential production device. The at least one computing device is configured to access the at least one credential production device for providing processing instructions for processing a credential substrate. The at least one computing device is authenticated by the at least one credential production device prior to providing the processing instructions to the at least one credential production device.

The following disclosure includes a method of securely processing a credential production system. At least one credential production device is accessed. A prompt is received from the at least one credential production device that is responded to correctly to be authenticated for use with the at least one credential production device. The prompt is enabled on the at least one credential production device by a central administrator device. Processing instructions are transmitted to the credential production device for processing a credential substrate after the correct response to the prompt

The following disclosure also includes a method of centrally managing a credential production system. An authentication feature is enabled on a first credential production device. A first password is assigned to the first credential production device such that the first computing device can transmit processing instructions to the first credential production device upon transmitting the first password to the first credential production device.

### BRIEF DESCRIPTION OF THE DRAWINGS

FIG. 1 is a schematic diagram of an exemplary credential production system.

FIG. 2 is a flowchart illustrating a method of centrally managing a credential production system.

FIG. 3 is a flowchart illustrating a method of centrally managing a credential production system.

FIG. 4 is an exemplary screenshot of a remote credential production panel.

### DETAILED DESCRIPTION OF THE PREFERRED EMBODIMENTS

Embodiments of the disclosure include the central management of secure production, issuance and manufacture of valuable documents. Such valuable documents include, for example, credentials, such as identification badges, loyalty cards, financial bank cards, phone cards, healthcare cards, passports, birth certificates or other printed documents where secure issuance is desire. Embodiments of the disclosure specifically include the secure production, issuance and manufacture of a document through the use of a central administrator device.

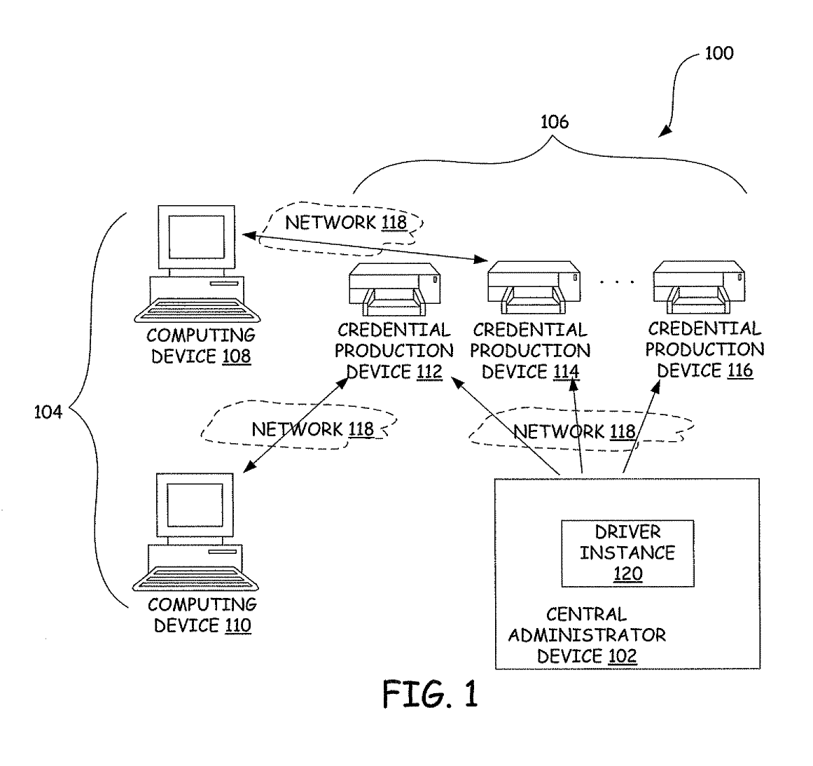

FIG. 1 illustrates a simplified schematic diagram of a credential production system 100 in accordance with an embodiment. Credential production system 100 includes a central administrator device 102, a plurality of computing devices 104 and a plurality of credential production devices 106. Central administrator device 102 is configured to act as a central point of administration for all credential production devices 106 in credential production system 100. Part of the functionality of central administrator device 102 is to create a plurality of different roles that define privileges for different users of credential production system 100. In one example, one of the plurality of roles created by central administrator device 102 includes an administrator role. The administrator role defines certain users with unrestricted privileges when interacting with credential production system 100. In another example, one of the plurality of roles created by central administrator device 102 includes an operator role. The operator role defines certain users with restricted privileges limited to operation when interacting with credential production system 100. In yet another example, one of the plurality of roles created by central administrator device 102 includes a manager role. The manager role defines certain users with restricted privileges limited to operation and control when interacting with credential production system 100.

In FIG. 1, the plurality of computing devices 104 include first computing device 108 and second computing device 110. It should be noted that credential production system 100 can include any number of computing devices. An example computing device is a personal computer, client device or other type of processor that can instruct a credential production device. Each of the computing devices 104 is configured to transmit production instructions to at least one of the plurality of credential production devices 106. For example, if one of the credential production devices 106 was a printer, one of the computing devices 104 is configured to transmit a print job to that credential production device. Also in FIG. 1, the plurality of credential production devices 106 include first credential production device 112, second credential production device 114 and third credential production device 116. As illustrated by the plurality of dots, credential production system 100 can include any number of credential production devices. Credential production devices are configured to process a credential substrate (e.g., card substrates, paper substrates, plastic substrates, substrates used to form passports and other valuable substrate documents) by using at least one consumable supply to perform at least one step in forming a credential (e.g., identification card, passport, employee badge and etc.). Exemplary credential production devices include printing devices (e.g., printer and etc) for printing images to a credential substrate, laminating devices for laminating overlaminate to a credential substrate and encoding devices for encoding data (e.g., writing a barcode, recording data to a magnetic stripe, writing data in a memory chip and etc.) to the credential substrate.

Administrator device 102 is coupleable to each of the plurality of credential production devices 106 and each of the plurality of computing devices 104 are coupleable to at least one of the plurality of credential production devices 106. For example, as illustrated, computing device 108 is coupleable to credential production device 114 and computing device 110 is coupleable to credential production device 112. Central administrator device 102 is coupled to and communicates with the plurality of credential production devices 106 over a network 118 and each of the plurality of computing devices 104 also are coupled to and communicate with at least one of the plurality of credential production devices 106 over network 118. In one embodiment, network 118 can be an internet or intranet. In such an embodiment, central administrator device 102 can be remotely located from credential production devices 106 and each computing device 104 can be remotely located from each credential production device 106. In addition, network 118 can be a local area network (LAN) or a wide area network (WAN). Such networking environments are commonly used in offices, enterprise-wide networks, on intranets and the internet. In another embodiment, central administrator device 102 can communicate with the plurality of credential production device 102 and each of the plurality of computing device 104 can also communicate with at least one of the plurality of credential production devices 106 directly using conventional methods such as including a physical communication link (i.e., cable connection such as, for example, a Universal Serial Bus) or a wireless communication link (such as, for example infrared or radio frequency).

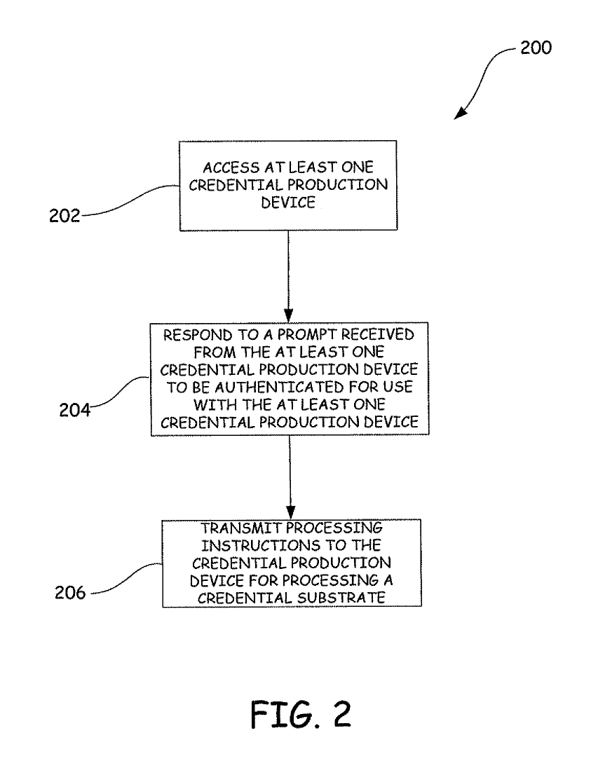

FIG. 2 is a flowchart 200 illustrating a method of securely processing a credential substrate in the credential production system 100 illustrated in FIG. 1. The steps described in flowchart 200 can be performed by each of the plurality of computing device 104. At block 202, each of the plurality of computing devices 104, such as computing device 110, accesses at least one credential production device, such as credential production device 112 of the plurality of credential production devices 106. At block 204, computing device 110 responds to a prompt received from credential production device 112. By responding to the prompt correctly, computing device 110 will be authenticated for use with credential production device 112. The prompt sent by credential production device 112 is configured for enablement by central administrator device 102. In general, the prompt is a request for a unique password that was assigned to credential production device 112 by a central administrator device 102. Other credential production devices 106 in credential production system 100 are assigned different unique passwords by central administrator device 102 than the password assigned to credential production device 112. The passwords assigned to the different credential production devices 106 can be as simple as alpha-numeric strings of characters. However, the passwords assigned to the different credential production devices 106 can be as complex as an encrypted certificate or a biometric template. At block 206, computing device 110 is configured to transmit processing instructions to credential production device 112 for processing a credential substrate after correctly responding to the prompt.

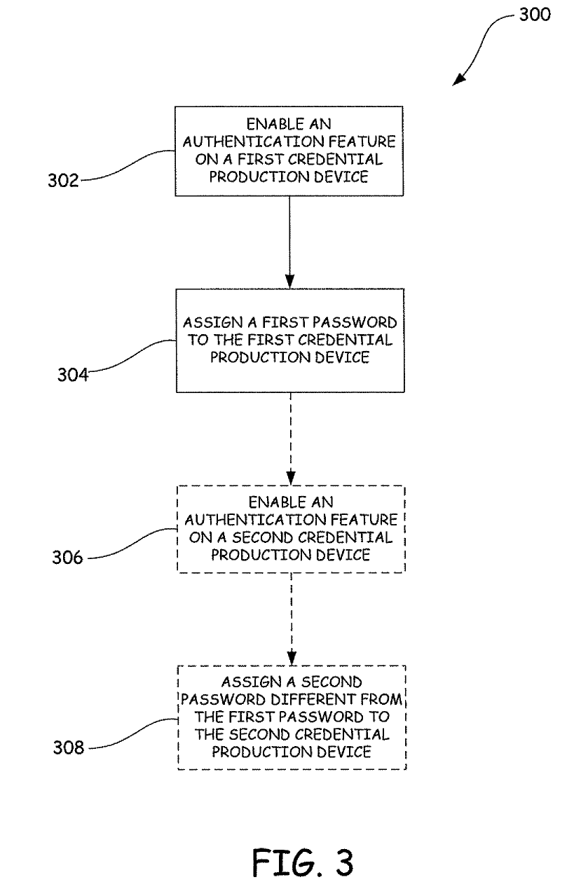

FIG. 3 is a flowchart 300 illustrating a method of centrally managing the credential production system 100 illustrated in FIG. 1. The steps described in flowchart 300 are performed by central administrator device 102. At block 302, central administrator device 102 is configured to enable an authentication feature on a first credential production device 112. At block 304, central administrator device 102 is configured to assign a first password to first credential production device 112 such that first computing device 110 can be authenticated by first credential production device 112. First computing device 110 is not allowed to transmit processing instructions to first credential production device 112 for the processing of a credential substrate until the first credential production device authenticates the first computing device. To be authenticated, first computing device 110 is required to transmit the correct first password assigned to first credential production device 112 upon attempting to access first credential production device 112. After transmitting the correct first password to first credential production device 112, first computing device 110 can transmit processing instructions to the first credential production device. The first password is a unique password reserved solely for first credential production device 112. The first password can be as simple as an alpha-numeric string of characters. However, the first password assigned to first credential production device 112 can be as complex as an encrypted certificate or a biometric template.

In an alternative embodiments (as shown in dashed lines in FIG. 3), after central administrator device 102 assigns a first password to first credential production device 112, at block 306, the central administrator device can enable an authentication feature on a second credential production device 114. At block 308, central administrator device 102 is configured to assign a second password different than the first password to second credential production device 114 such that second computing device 108 can be authenticated by second credential production device 114. Second computing device 108 is not allowed to transmit processing instructions to second credential production device 114 for the processing of a credential substrate until the second credential production device authenticates the second computing device. To be authenticated, second computing device 108 is required to transmit the correct second password assigned to second credential production device 114 upon attempting to access second credential production device 114. After transmitting the correct second password to second credential production device 114, second computing device 108 can transmit processing instructions to the second credential production device. The second password is a unique password reserved solely for second credential production device 114. The second password can be as simple as an alpha-numeric string of characters. However, the second password assigned to second credential production device 114 can be as complex as an encrypted certificate or a biometric template.

Although FIG. 1 illustrates that first computing device 10 is in communication with first credential production device 112 and second computing device 108 is in communication with second credential production device 114, it should be noted that any of computing devices 104 can be in communication with any of credential production devices 106. In addition, any of computing devices 104 can be in communication with more than one of credential production devices 106, For example, first computing device 110 can attempt to access first credential production device 112 and/or second credential production device 114. It is the responsibility of the user to respond to the prompt issued by either the first credential production device 112 or the second credential production device 114 with the correct password. Therefore, if first computing device 110 is attempting to access first credential production device 112, the user need to instruct the first computing device to transmit the correct password assigned to the first credential production device. If the first computing device 110 is attempting to access second credential production device 114, the user needs to instruct the first computing device to transmit the correct password assigned to the second credential production device.

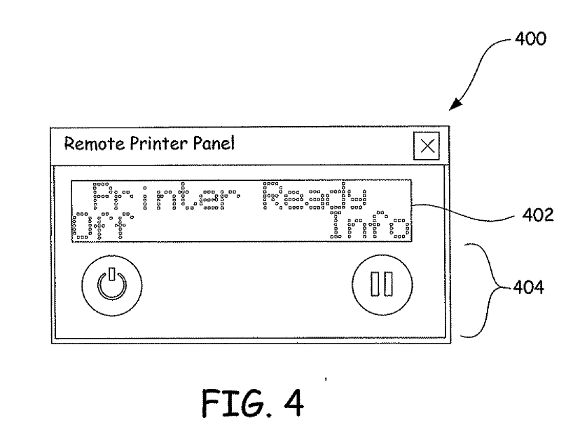

FIG. 4 illustrates an exemplary screen shot 400 of a remote credential production panel. In one embodiment, the remote credential production panel is provided on a display of a central administrator device, such as central administrator device 102. Through remote credential production panel, a user, generally a user having an administrator role, is allowed to control an associated credential production device, such as one of the plurality of credential production devices 106. The remote credential production panel also includes the replication of data regarding jobs being processed, processed jobs and/or jobs to be processed.

For example the remote credential production panel or virtual panel illustrated in FIG. 4 includes a display section 402 that represents a replication of a display panel, such as a liquid crystal display, that is built into a credential production device, such as credential production device 112. Information provided by the remote credential production panel is provided in substantially real time from information displayed on the display panel built into credential production device 112. As illustrated in FIG. 4, in addition to remote credential production panel including display section 402 showing information from a display panel built into credential production device 11 2, remote credential production panel also includes a button section 404 that replicates and reproduces buttons contained on a control panel of credential production device 112. Such replicated and reproduced buttons can be activated by central administrator device 102 to configure credential production device 112 and/or monitor the operation of credential production device 112.

In one embodiment, central administrator device 102 includes a single credential production device driver instance, such as single device driver instance 120 illustrated in FIG. 1. Device driver 120 is configured to remotely access all of the display panels and control buttons for each of the plurality of credential production devices 106. Device driver 120 can functionally access all of the display panels and control buttons for each of the plurality of credential production devices 106 by dynamically changing configured IP addresses in the device driver based on the credential production device that a user would like to monitor or control using central administrator device 102. The dynamic nature of device driver 120 eliminates the need to have unique drivers for each credential production device on central administrator device 102.

Although the present invention has been described with reference to preferred embodiments, workers skilled in the art will recognize that changes may be made in form and detail without departing from the spirit and scope of the invention.

What is claimed is:

1. A credential production system comprising:
at least one credential production device;
at least one computing device in communication with the at least one credential production device, the at least one computing device configured to access the at least one credential production device for providing processing instructions for processing a credential substrate; and
a central administrator device configured to enable an authentication feature on the at least one credential production device such that the at least one computing device is authenticated by the at least one credential production device prior to providing the processing instructions to the at least one credential production device.

2. The credential production system of claim 1, wherein the central administrator is further configured to assign the at least one credential production device with a unique password after the authentication feature is enabled.

3. The credential production system of claim 2, wherein the authentication feature comprises a prompt communicated to the at least computing device in response to the at least one computing device accessing the at least one credential production device, the prompt requesting the unique password assigned to the at least one credential production device.

4. The credential production system of claim 1, wherein the central administrator device is further configured to create a plurality of roles that define privileges for different users of the credential production system.

5. The credential production system of claim 4, wherein one of the plurality of roles created by the central administrator device comprises an administrator role, the administrator role defines certain users with unrestricted privileges when interacting with the credential production system.

6. The credential production system of claim 4, wherein one of the plurality of roles created by the central administrator device comprises an operator role, the user role defines certain users with restricted privileges limited to operation when interacting with the credential production system.

7. The credential production system of claim 4, wherein one of the plurality of roles created by the central administrator device comprises a manager role, the manager role defines certain users with restricted privileges limited to operation and control when interacting with the credential production system.

8. The credential production system of claim 1, wherein the central administrator device includes at least one remote credential production panel view which is a virtual replication of a display panel and a control panel the panel on the at least one credential production device.

9. The credential production system of claim 8, wherein a user can remotely configure operation and monitor operation of the at least one credential production device using the at least one remote credential production panel on the central administrator device.

10. The credential production system of claim 8, wherein the central administrator device comprises a device driver that is configured to dynamically change Internet Protocol addresses for each credential production device in the credential production system based on the credential production device that is to be monitored.

11. A method of securely processing a credential substrate comprising:
accessing at least one credential production device;
responding correctly to a prompt received from the at least one credential production device to be authenticated for use with the at least one credential production device, the prompt being enabled on the at least one credential production device by a central administrator device;
transmitting processing instructions to the credential production device for processing a credential substrate after responding correctly to the prompt.

12. The method of claim 1, wherein responding to the prompt received from the at least one credential production device comprises responding correctly to the prompt by supplying the at least one credential production device with a unique password assigned to the credential production device by the central administrator device.

13. A method of centrally managing a credential production system, the method comprising:
enabling an authentication feature on a first credential production device; and
assigning a first password to the first credential production device such that the first computing device can transmit processing instructions to the first credential production device upon transmitting the first password to the first credential production device.

14. The method of claim 13, further comprising:
enabling an authentication feature on a second credential production device; and
assigning a second password different than the first password to the second credential production device such that the second computing device can transmit processing instructions to the second credential production device upon transmitting the second password to the second credential production device.

15. The method of claim 13, further comprising creating a plurality of roles that define privileges for users of the credential production system.

16. The method of claim 15, wherein creating the plurality of roles comprises creating an administrator role, the administrator roles defines certain users with unrestricted privileges when interacting with the credential production system.

17. The method of claim 15, wherein creating the plurality of roles comprises creating a user role, the user role defines certain users with restricted privileges of operation when interacting with the credential production system.

18. The method of claim 15, wherein creating the plurality of roles comprises creating a manager role, the manager role defines certain users with restricted privileges of operation and control when interacting with the credential production system.

19. The method of claim 14, further comprising providing a remote credential production panel which is a virtual replication of a display panel and a control panel of one of the first credential production device and the second credential production device.

20. The method of claim 19, further comprising providing a device driver that is configured to dynamically change Internet protocol addresses to change between displaying and controlling the display panel and the control panel of the first credential production device and displaying and controlling the display panel and the control panel of the second credential production device.
